(19) United States
(12) Patent Application Publication
(10) Pub. No.: US 2024/0072231 A1
(43) Pub. Date: Feb. 29, 2024

(54) Ridged 3-dimensional battery electrodes for enhancing rate capability

(71) Applicant: National Technology & Engineering Solutions of Sandia, LLC, Albuquerque, NM (US)

(72) Inventors: Jorge Antonio Cardenas, Albuquerque, NM (US); John Paul Bullivant, Albuquerque, NM (US); Katharine Lee Harrison, Albuquerque, NM (US); Adam W. Cook, Albuquerque, NM (US); Albert Alec Talin, Dublin, CA (US)

(21) Appl. No.: 17/895,285

(22) Filed: Aug. 25, 2022

(51) Int. Cl. H01M 4/04; H01M 4/139

(52) U.S. Cl. CPC H01M 4/0404; H01M 4/139; H01M 2004/021

(57) ABSTRACT

Custom-form batteries can supply complex, practical systems with an optimal energy density that wouldn't otherwise be possible using traditional battery form-factors. For example, iron disulfide (FeS₂) is a prominent conversion cathode of commercial interest. 3D direct-ink write (DIW) printing of FeS₂ inks can be used to produce ridged cathodes from the filamentary extrusion of highly concentrated FeS₂ inks (60-70% solids). These ridged cathodes exhibit optimal power, uniformity, and stability when cycled at higher rates (in excess of C/10). Meanwhile, functional cells with custom-form wave-shaped electrodes (e.g., printed FeS₂ cathodes and pressed lithium anodes) exhibit improved performance over similar cells in planar configurations. In general, the DIW of concentrated inks is a viable path toward the making of custom-form conversion lithium batteries. More broadly, ridging is found to optimize rate capability.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to battery electrodes and, in particular, to ridged 3-dimensional battery electrodes for enhancing rate capability.

### BACKGROUND OF THE INVENTION

Additive manufacturing (AM) is an attractive technology with the potential to produce non-conventional (or custom-) form factor energy storage devices which can optimize practical energy densities in applications for which packing efficiency must be maximized. See S.-H. Kim et al., Nano Lett. 15(8), 5168 (2015); C. Reyes et al., ACS Appl. Energy Mater. 1(10), 5268 (2018); and Y Pang et al., Adv. Funct. Mater. 30(1), 1906244 (2020). Several additively manufactured lithium ion batteries have been demonstrated using lithium iron phosphate (LFP) cathodes and lithium titanate (LTO) or graphite anodes. See I. Ben-Barak et al., J. Electrochem. Soc. 166(3), A5059 (2018); L. J. Deiner et al., Adv. Eng. Mater. 21(5), 1801281 (2019); T. S. Wei et al., Adv. Mater. 30(16), 1703027 (2018); X. Yu et al., Adv. Mater. Technol. 4(11), 1900645 (2019); and A. Maurel et al., Chem. Mater. 30(21), 7484 (2018). However, these materials were strategically chosen to optimize for manufactability and cyclability, not necessarily energy density. In contrast, lithium conversion chemistries (where cathodes react with Li⁺ and convert to new species as opposed to Li⁺ insertion in conventional L-ion batteries) paired with Li metal anodes exhibit even higher energy densities. When deposited with AM approaches, conversion chemistries offer a path towards an optimized energy storage technology unconstrained by complex architectures. However, conversion chemistries often exhibit cyclability challenges, and there have been fewer instances non-conventional shape of custom-form lithium conversion batteries demonstrated. See S.-H. Yu et al., Acc. Chem. Res. 51(2), 273 (2018). Of the few that have been demonstrated, those based on direct-ink write (DIW) lithium-sulfur (Li—S) cathodes are the most prominent. See X. Gao et al., Nano Energy 56, 595 (2019); and K. Shen et al., Adv. Energy Mater. 8(4), 1701527 (2018). Though Li—S batteries are promising due to their high energy density, low cost, and manufacturability, they are plagued by self-discharge problems due to Li-polysulfide formation, and so numerous efforts are focused on overcoming these challenges. See G. Wen et al., Chem. Mater. 32(11), 4518 (2020).

Alternatively, iron disulfide (FeS₂) is another prominent conversion cathode material of interest due to its high theoretical energy density, low cost, thermal stability, and earth abundance. See S. S. Zhang et al. Electrochim. Acta 176, 784 (2015). Li—FeS₂ is a well-known commercial Li-primary system with expansive effort put forth in demonstrating efficient electrochemical reversibility, allowing for high energy density cycling in secondary batteries. See Y Shao-Horn et al., J. Electrochem. Soc. 149(11), A1499 (2002); and A. K. Haridas et al., ChemSusChem 11(20), 3625 (2018). Though it suffers from polysulfide problems similar to Li—S, the formation of polysulfides in Li—FeS₂ can be mitigated more easily because the sulfur/polysulfide reaction mechanism is only one part of the overall Li—FeS₂ battery reaction mechanism for storing charge. Mitigation of polysulfide formation in Li—FeS₂ batteries is an active area of research, but a common mitigation is to use a limited voltage cycling window. See B. N. B. Schorr et al., ACS Appl. Nano Mater. 4(11), 11636 (2021). Despite the promise of the Li—FeS₂ system, the DIW printing of FeS₂ inks (or “slurries, pastes”) for applications requiring custom-form factors has yet to be demonstrated.

Traditional 2D methods of electrode coating, such as slot-die or blade coating, use inks optimized for high-throughput deposition onto planar sheets. See A. Toor et al., Nano Energy 82, 105666 (2021). However, in the preparation of inks for DIW printing, ink formulation and rheology must be considered. Firstly, the rheology of the paste must be compatible with the DIW printing process (shear thinning with yield stress values typically below 1000 Pa). See D. J. Roach et al., Smart Mater. Struct. 27(12), 125011 (2018). Secondly, for applications where ink is extruded onto non-planar surfaces, the paste must have a high enough yield stress to support itself on those surfaces without significant reflow prior to drying. See J. A. Lewis, Adv. Funct. Mater. 16(17), 2193 (2006). Beyond printability, ink solid concentration can also impact film surface and volume morphology at the nano-, micro- and macro-scales. For instance, ink concentration is known to impact film consolidation and porosity. In electrochemical applications, specifically electrodes, porosity has been shown to have a significant impact on electrochemical performance, rate, overall cell capacity, and volumetric energy density. See N. Kang et al., Nat. Commun. 10(1), 1 (2019); and R. Rodriguez et al., ACS Appl. Energy Mater. 4(9), 9507 (2021). At the macroscale, paste concentration can also impact surface profile at the cathode-electrolyte interface, where the filamentary shape of extruded beads from high concentration inks produces ridges in a printed electrode due to tool path rastering. In the context of cell electrodes, investigations of electrode ridging due to printing are limited and ridging's impacts on electrochemical performance are not well understood. See J. Hu et al., Adv. Energy Mater. 6(18), 1600856 (2016).

### SUMMARY OF THE INVENTION

The present invention is directed to an ink, comprising solid particles comprising an electrochemically active electrode material, a conductive additive, a binder, and a solvent, and a method for fabricating an electrode, comprising depositing the ink on a current collector. A variety of battery cathodes and anodes can be fabricated using this method, such as conversion cathodes, intercalation cathodes, intercalation anodes, conversion anodes, and Li-alloying anodes. The inks can be deposited using a wide variety of deposition or printing methods, such as extrusion printing, casting, or slot die printing. If the viscosity of the ink is sufficiently high, ridged and non-planar electrodes can be fabricated using this method. For example, the ink can have a yield stress greater than 1 Pa. The invention is further directed to a ridged 3-dimensional battery electrode comprising the deposited ink on a current collector.

For example, the electrochemically active electrode material can comprise FeS₂ cathode particles, the conductive additive can comprise carbon, the binder can comprise polyvinyldifluoride, and the solvent can comprise N-methyl-2-pyrrolidone. The electrochemically active electrode material can alternatively comprise an anode material, such as silicon, that undergoes alloying with lithium to enable high charge storage capacity and high energy density when paired with a cathode. Because of the large volume expansion from large amounts of lithium incorporation in silicon, silicon behaves similar to conversion cathode materials like FeS₂ described herein. The ridging method described herein to improve rate capability of FeS₂ cathodes is expected to extend to improvement in a variety of conversion and alloying cathode and anode materials and is expected to also to improve mechanical stability of conversion and alloy electrodes by enabling space for volume expansion within the electrode material. Even intercalation materials can benefit from the techniques described herein because 3D electrode architectures fabricated in other ways have shown improvement in rate capability. See D. S. Ashby et al., ACS Appl. Energy Mater. 3(9), 8402 (2020); L. Xue et al., Adv. Energy Mater. 11(14), 2100420 (2021); C. Shen et al., Electrochim. Acta 349, 136331 (2020); and C. Xu et al., J. Power Sources 492, 229638 (2021).

As an example, an investigation of FeS₂ ink concentration was carried out to determine its impacts on ink rheology, film shape retention, cathode morphology, and electrochemical performance. It was found that 40-70% solid inks adequately retained their shape when drying on non-planar surfaces, 60-70% solid inks exhibited prominent ridges from printing, and electrode porosity decreased with increasing ink concentration. Electrochemically, all conditions performed nearly identically at slow rates (C/50) but at faster rates, ridged electrodes cycled most stably and with highest capacity. This suggests that the ridged architectures afforded by deposition of these high ink concentrations is a simple way of generating electrodes with improved rate capability. FeS₂ cathodes were printed on and lithium anodes were pressed to waveshape current collectors which were then constructed in coin cells to demonstrate performance of these non-planar electrodes, which performed similarly with slight improvements over planar configurations. Therefore, DIW printing is a viable path for producing complex electrode shapes for alternative form-factor batteries, and more broadly, electrode ridging can be an inexpensive and scalable way to produce more rate capable batteries even in planar configurations.

### BRIEF DESCRIPTION OF THE DRAWINGS

The detailed description will refer to the following drawings, wherein like elements are referred to by like numbers.

FIG. 1 is a laser diffraction particle size analysis of FeS₂ and carbon powder ball milled together in an 8:1 ratio.

FIG. 2a is a graph of viscosity versus shear rate for FeS₂ inks at solid concentrations ranging from 30-70%. FIG. 2b is a graph of shear modulus versus stress for the FeS₂ inks. FIG. 2c is a graph of yield stress versus ink solid concentration for the FeS₂ inks. FIG. 2d is a schematic illustration of a FeS₂ ink conformally printed over a non-planar surface.

FIG. 3a is a photograph of a 7 mg/cm² film printed from a 30% solid FeS₂ ink after drying on a non-flat surface. FIG. 3b is a photograph of a 7 mg/cm² film printed from a 40% solid ink after drying on a non-flat surface, showing shape retention.

FIG. 4a shows optical images of 10 FeS₂ films produced from various ink concentrations and deposition methods punched into 16 mm diameter electrodes. FIG. 4b shows optical images of FeS₂ films at 1000× taken areally (scale bars are 100 μm). FIG. 4c shows surface profiles of printed films. FIG. 4d shows surface profiles of cast films. FIG. 4e is a plot of the surface porosity index which quantifies image data shown in FIG. 4b, showing surface image trends as ink concentration is increased. FIG. 4f is a cross-sectional scanning electron microscope (SEM) image of FeS₂ film printed from a 30% solid ink. FIG. 4g is a cross-sectional SEM image of an FeS₂ film printed from a 60% solid ink. FIG. 4h is a mercury porosimeter plot of the log of the differential intrusion curve for 30% printed and 60% printed FeS₂ films.

FIG. 5a is a schematic illustration of a planar Li—FeS₂ coin cell assembly showing each layer. FIG. 5b is a plot of capacity versus cycle count for Li—FeS₂ coin cells from cathodes printed using various ink concentrations. FIG. 5c is a plot of capacity versus cycle count for Li—FeS₂ coin cells from cathodes cast using various ink concentrations.

FIG. 6a is a graph of specific discharge capacity versus cycle number of printed FeS₂ cathodes discharged at C/50 to C/5. FIG. 6b is a graph of specific discharge capacity versus cycle number of cast FeS₂ cathodes discharged at C/50 to C/5. FIG. 6c is a graph of specific discharge capacity of printed cells at the 19^{th} cycle (C/5) of the rate capability plot of FIG. 6a. FIG. 6d is a graph of specific discharge capacity of cast cells at the 19^{th} cycle (C/5) of the rate capability plot of FIG. 6b.

FIG. 7a is a schematic illustration of a wave-shaped anode and cathode in coin cell assembly and an image of a 40% solid FeS₂ ink being microextruded onto a non-planar wave-shaped aluminum current collector. FIG. 7b is a graph of capacity versus cycle number for printed and cast 40% solid FeS₂ inks on wave-shaped and planar current collectors at C/50. FIG. 7c is a graph of capacity from C/50 to C/5.

### DETAILED DESCRIPTION OF THE INVENTION

The present invention is directed to ridged electrodes printed from highly concentrated inks. As used herein, ridging refers to engineered, periodic, and controlled thickness variations along one or more dimensions of a battery electrode, imparted during or after the deposition process. These thickness variations can be distinguished from surface roughness through their scale, periodicity, and the engineered manner in which they are imparted (through the deposition process or any post-manufacturing process). As an example of the invention, it was demonstrated that cathodes with a ridged interface, printed from highly concentrated FeS₂ inks, cycle with optimal power, uniformity, and stability at faster rates. The printing of FeS₂ inks onto planar and non-planar current collectors (CCs) was also demonstrated and their electrochemical performance was shown to be similar to or surpass the coating of the same inks on planar surfaces using traditional coating methods. These findings were produced in an investigation of FeS₂ ink solid concentration and its impacts on ink rheology, printability, film shape retention, film morphology, and their impacts on cell capacity, cyclability, and rate capability. FeS₂ inks were prepared at solid concentrations ranging from 30-70% and DIW printed (hereinafter referred to as “printed”) or blade coated (hereinafter referred to as “cast”) to form FeS₂ cathodes. Inks in the 40-70% solid inks exhibited sufficient yield stress (>1 Pa) to retain shape when printed onto non-planar surfaces. Inks printed from the 60-70% solids range formed cathodes that exhibited prominent ridging and produced the most stable and rate capable cells. Additionally, it was found that pore structure in the 100 nm to 1 μm range decreased with increasing solids concentration in the inks used to make electrodes, however, this did not seem to impact the electrochemical performance in contrast to prior works which used calendaring to produce pore structure differences. See N. Kang et al., Nature Comm. 10(1), 1 (2019). Therefore, DIW printing is a viable path for producing custom-form FeS₂ electrodes. Furthermore, ridging, as introduced through the manufacturing process, was found to optimize cell rate capability.

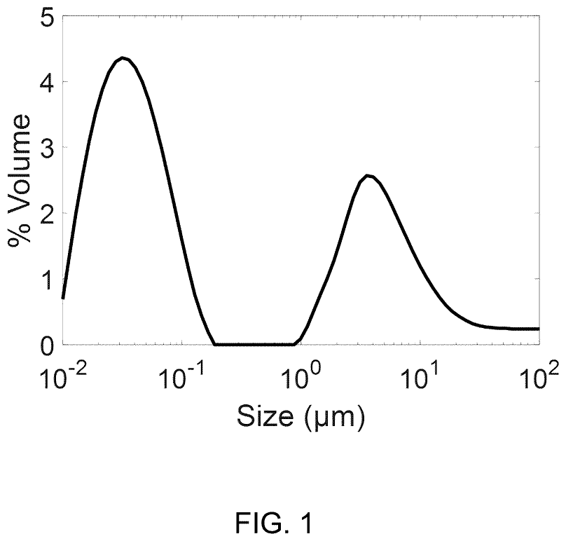

All exemplary electrodes evaluated were derived from the same 30 g batch of ball milled FeS₂:carbon (8:1) powder. The particle size distribution for this powder is shown in FIG. 1. Most particle sizes are compatible with syringe extrusion, although smaller particles generally provide better electrochemical performance. This powder was mixed with a polyvinyldifluoride (PVDF) binder in N-methyl-2-pyrrolidone (NMP) solvent to produce ink concentrations in the 30-70 wt % solids range (˜430-2330 mg/mL), while keeping the ratio of FeS₂:carbon:PVDF constant at 8:1:1 in all cases. The FeS₂ inks produced utilized Kureha 1300 (molecular weight=3.5*10⁵ Da) as the PVDF binder, which resulted in inks with a wide range of rheological properties that were all syringe extrudable through a 250 μm diameter nozzle.

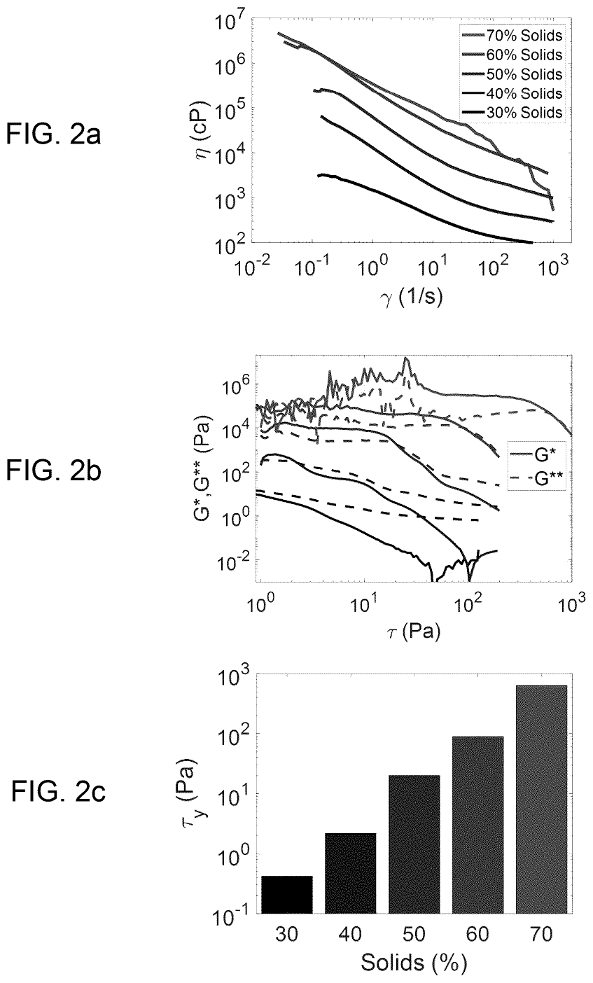

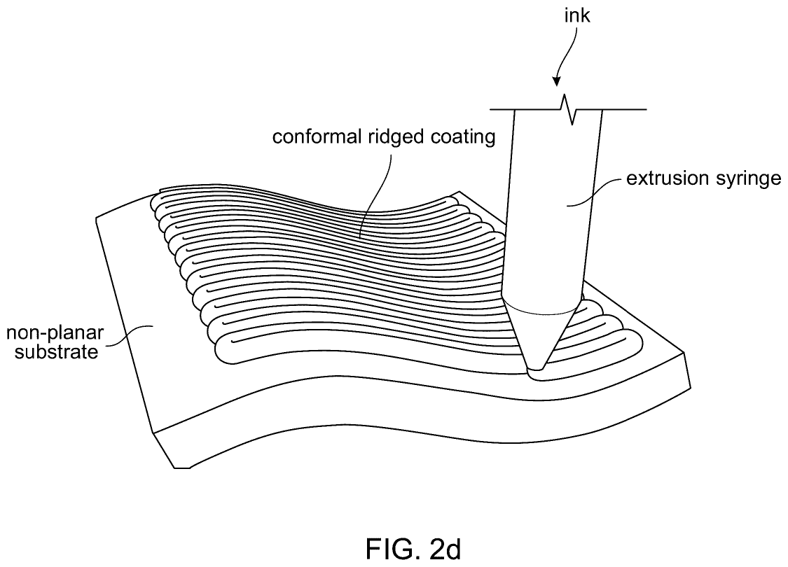

A plot of each ink's shear viscosity, oscillatory shear storage and loss moduli, and shear yield stress is shown in FIGS. 2a, 2b, and 2c, respectively. The viscosity of each ink (FIG. 2a) rose exponentially with increasing ink concentration up until 70% solids, which exhibited an irregular viscosity versus shear rate curve, likely due to the highly concentrated nature of the slurry. Similarly, irregularities amongst 70% solid inks were observed in blade coating, as described below. Meanwhile, each ink's shear yield stress (FIG. 2c) increased exponentially and predictably throughout the 30-70% solid concentration range, with yield stress values ranging from 0.1 to 1000 Pa. These values are relevant for shape retention behavior. A higher molecular weight binder (Solvay 5130, molecular weight=1*106 Da) was also explored with FeS₂ inks, however, slight changes in this binder's concentration led to even larger changes in rheological behavior, precluding an investigation of the impacts of ink concentration. In contrast, the Kureha 1300 binder allowed for more gradual changes in rheology from 30-70% solid concentrations, allowing for the printing of both dilute and highly concentrated inks.

Once inks were homogeneously mixed, they were exposed to air and loaded into a syringe for DIW printing. Conceptually, an illustration of the syringe extrusion 3D printing process is shown in FIG. 2d, where slurry is extruded through a 250 μm nozzle while rastering across an arbitrary surface to produce a conformal coating. The DIW printer used was a custom-built tool consisting of linear stages moving the nozzle along the x, y, and z axes relative to the substrate. A linear syringe pump moving at constant velocity (as opposed to constant force) was then used to pressurize the syringe. With the FeS₂ ink concentration taken into account, the toolpath, motor velocities, and plunger velocity were then all programmed such that each printed film had an active material areal mass density of 7 mg/cm². To produce planar cathodes, FeS₂ inks were printed and rastered onto 20 μm thick aluminum foil substrates to produce 60 mm by 60 mm wet films. These films were then dried at 70° C. for one hour to remove the NMP solvent, then punched out using a 16 mm diameter electrode puncher and transferred to an argon glovebox for cell assembly. To compare against a traditional slurry deposition method, the same FeS₂ inks described above were also blade coated (also referred to as “cast”) onto aluminum foil substrates, using the gap between blade and substrate to achieve the desired 7 mg/cm² mass loading for each film. The same post-processing steps were used with blade coated films and printed films.

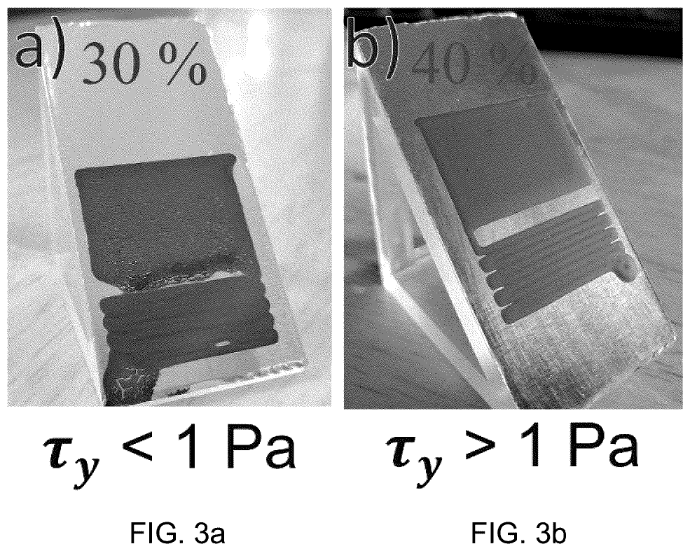

Beyond the relationship between rheological behavior and printability, rheology also determines how well printed films hold shape on non-planar surfaces throughout their drying process. To assess shape retention characteristics, FeS₂ inks were printed directly onto 45° surfaces laminated with aluminum foil and allowed to dry overnight at room temperature. Each film was printed such that the dry film would have a 7 mg/cm² FeS₂ active mass loading. At ink concentrations of 30% solids (corresponding to shear yield stress values below 1 Pa), inks would reflow before drying resulting in nonuniform film characteristics, as shown in FIG. 3a. In contrast, ink concentrations at and above 40% solids (corresponding to shear yield stress values greater than 1 Pa) adequately and uniformly retained shape, as shown in FIG. 3b. These results suggest that 40% solid inks and above are likely to retain their shape when printed on a non-planar surface. However, these results will differ depending on film thickness, ink composition, and substrate. In particular, the solids concentration necessary to achieve a high viscosity ink will depend on electrochemically active electrode material, conductive additive, binder, and solvent used and their relative concentrations and particle sizes.

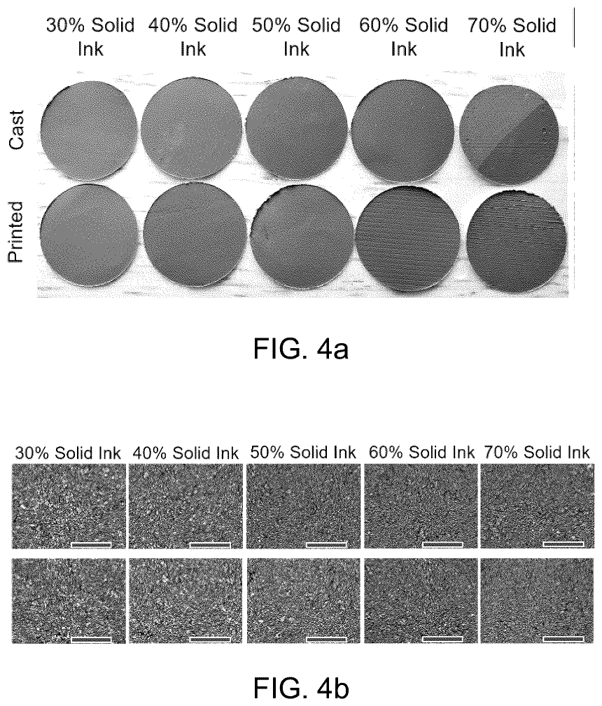

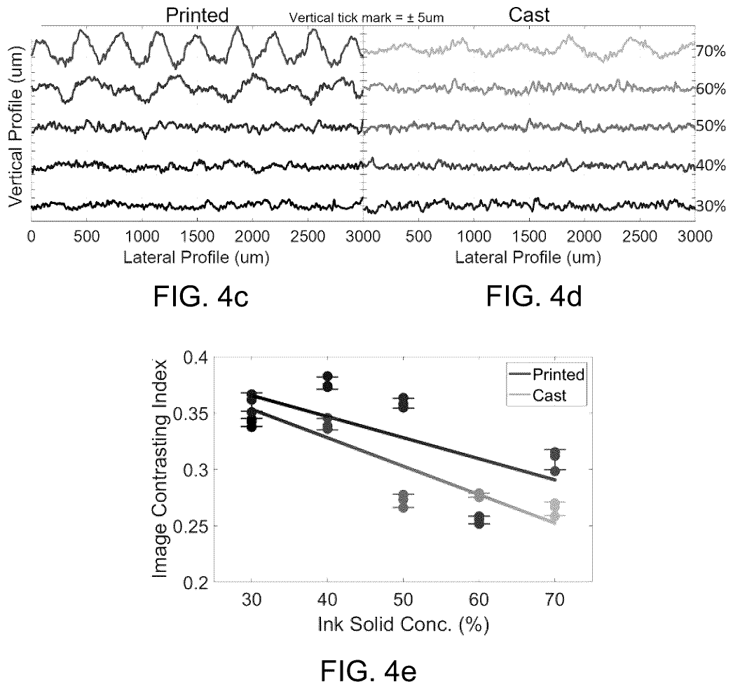

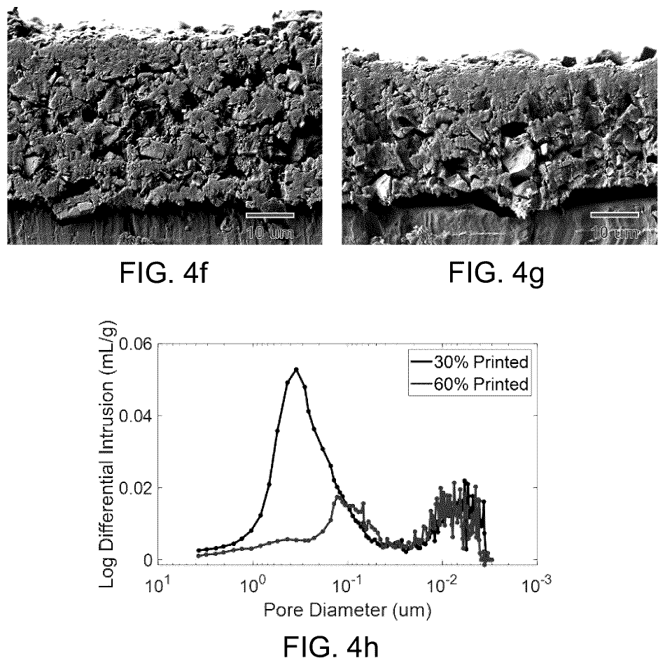

In addition to rheology, ink concentration also impacts film consolidation as well as nano-, micro- and macroscale morphology. These morphological changes between cathodes impact characteristics such as color, thickness, surface profile, and porosity, which can thereby influence electrochemical performance. Images of post-processed cathodes are shown in FIG. 4a, depicting representative cathodes of all conditions tested between printed and cast inks with concentrations ranging from 30-70% solids. As can be seen in FIG. 4a, printed cathodes become noticeably darker and more ridged as ink concentration is increased. Similar changes in color are present in the cast cathodes, but surprisingly, the cathodes cast from 70% solid inks exhibited ridging, perhaps due to irregularities associated with casting highly viscous slurries during the blade coating process. This is consistent with irregularities observed in shear viscosity measurements of 70% solid inks as shown in FIG. 2a. Profilometry data taken across each of the imaged cathodes is shown in FIGS. 4c and 4d, reflecting the ridging that can already be seen in the FIG. 4a images.

To better capture these trends at the microscale, a visible light microscope was used to image cathode surfaces at 1000×, as shown in FIG. 4b. To capture the visual trends among these images, a machine vision contrasting algorithm was applied to each image and used to establish a correlation between image data and ink concentration, as shown in FIG. 4c. Each image was taken under the same focusing and lighting conditions so that the only features changing between images are structural differences in the cathode. Once images were taken, each image was contrasted using the same thresholding algorithm, after which the ratio between light pixels and dark pixels were quantified for each sample (in triplicates along random areas of each sample). This ratio, which was called the Image Contrasting Index, is plotted along the y-axis of FIG. 4e and suggests there is a significant correlation between ink concentration and cathode surface microstructure. However, this metric should not be used as a measure of bulk porosity or even surface porosity. However, the observation of this relationship could potentially be relevant for further optimization of ink formulation and cathode deposition methods using machine learning algorithms. See D. J. Roach et al., Addit. Manuf. 41, 101950 (2021).

To more closely capture these microstructural differences, cross-sections of cathodes printed from 30% solid and 60% solid inks were scanning electron microscope (SEM) imaged and are shown in FIGS. 4f and 4g, respectively. Differences in thickness between these samples are clear from these images, despite having the same active mass loadings (7 mg/cm²), verifying that more concentrated inks lead to more dense, less porous cathodes. Less clear from the SEM images are the differences between pore morphologies. To quantify these differences, cathodes printed from 30% and 60% solid inks were subjected to mercury intrusion porosimetry (MIP). Seventeen punched electrodes (16 mm diameter) printed from each ink concentration were placed in a MIP chamber, and the chamber was filled with mercury and incrementally pressurized to intrude mercury into the open pore space of the samples. From this process, an intrusion curve (plot of the volume of mercury intruded versus sample pore size on a log axis) was produced for each sample. Taking the slope of this plot (with pore size on a log axis), yields the log differential intrusion curve (∂V/∂ log(D)), where V is the volume of mercury intruded and D is the sample pore size, which is plotted for both 30% and 60% printed samples in FIG. 4h. From this data, it can be seen that porosity in the 100 nm to 1 μm pore size range is what is primarily impacted by the change in ink concentration, with the pore size distribution decreasing and shifting slightly downward as ink concentration is increased. This means that the change in thickness observed in SEM images is achieved by closing relatively large micron sized pores rather than smaller pore spaces. This MIP data, in addition to SEM, optical image, and profilometry data outline the micro- and macro-structural differences between FeS₂ cathodes as ink concentration is increased, laying the foundation for establishing structure-property relationships in the context of electrochemical testing.

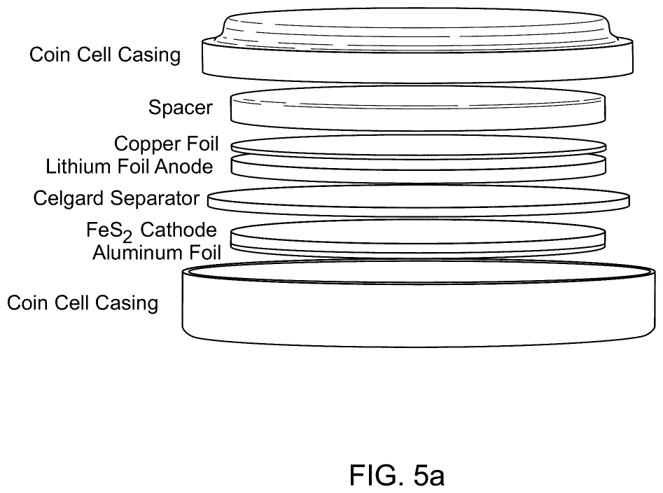

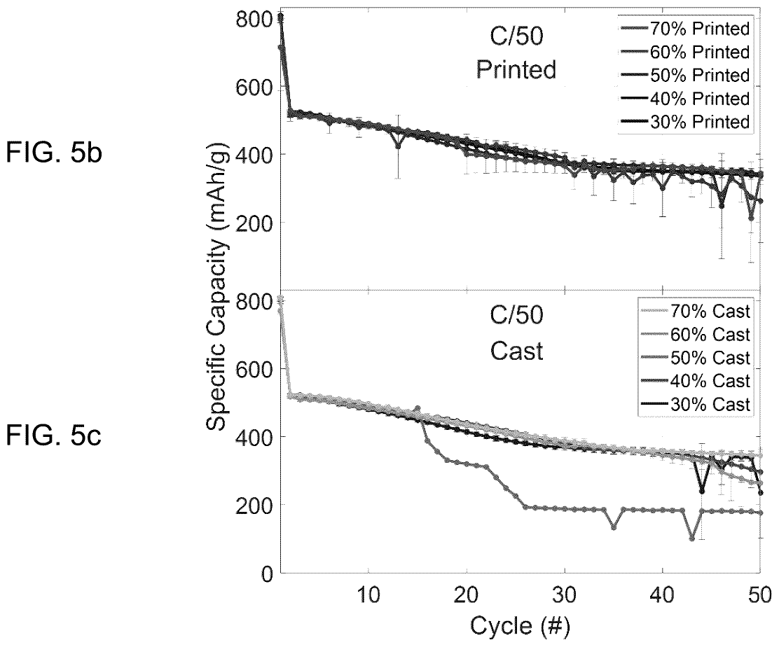

To evaluate the electrochemical performance of these various cathode morphologies, a traditional coin cell configuration was chosen to investigate printed and cast FeS₂ films so that any differences in electrochemical performance between the two deposition conditions could be established, without added complications related to cell geometry or packaging. The assembly of planar Li—FeS₂ cells was carried out using CR2032 coin cell cases, a wave spring, stainless steel spacers to fill empty space in the cell and engage the spring, printed or cast FeS₂ films, a Celgard 2400 separator, 750 μm Li foil, and Al/Cu current collectors (CCs), as shown in FIG. 5a. In the preliminary stages of this investigation, it was found that a spacer thickness of 1100 μm provided sufficient pressure within the cell for reliable contact and stable high-capacity cycling. The need for sufficient pressure has previously been shown to improve FeS₂ cycling. See D. S. Ashby et al., ACS Appl. Energy Mater. A 1 M LiTFSI in 1:1 DOL/DME (v/v) electrolyte was used as described above.

Specific discharge capacity versus cycle count is plotted for cells containing both printed and cast FeS₂ cathodes at C/50 in FIGS. 5b and 5c, where each data point consists of the average and standard deviation of at least three separate cells. In the first 15 cycles of each case tested, cycling characteristics are typically nearly indistinguishable for both printed and cast electrodes as well as at each ink concentration tested. At the 20^{th} cycle, an instability occurs in one of the cells using a cathode printed from 70% solid ink, which then recovers and stabilizes after several cycles. Additionally, several instabilities occur at the 15^{th} cycle in two cells using cathodes cast from 50% solid inks, which begin to fail while two continue to cycle normally, throwing off the average and standard deviation of this data set. For this reason, the cycling profile for cells using cast electrodes as depicted in FIG. 5b has error bars omitted for samples cast from 50% solid inks. Otherwise, the majority of cells cycle stably up to 40-50 cycles with a few noise instabilities occurring in this range. Overall, this data suggests two things: (1) The FeS₂ powder, ink preparation, deposition, and assembly processes produce uniform loading electrodes with high utilization of active material that is well connected to the CC, and (2) ink concentration and deposition conditions have little to no nominal impact on cell performance when cycled at the slow rate of C/50.

The differences in ink composition and deposition method are more likely to impact electrochemical performance when the cells are cycled at higher rates because rate capability is more sensitive to differences in electrode microstructure such as changes in thickness, porosity, and ridge architecture. Up to this point, no results have been shown of FeS₂ cycling at rates higher than C/50. Previous studies have found that more porous electrodes cycled more stably, due to their open pore structure, allowing lithium ions to access every part of the electrode more quickly due to a less tortuous transport path through more open pores. See N. Kang et al., Nat. Commun. 10(1), 1 (2019). Therefore, FeS₂ films printed from lower concentration inks were hypothesized to be more rate capable. If this were the case, the decreased porosity in electrodes printed from high-concentration inks may threaten the ability to develop batteries in complex form factors for which inks with high yield stress and viscosity are needed to retain as-printed shape on complex surfaces. Remarkably, the opposite trend was found; cathodes printed from more concentrated inks performed more stably and delivered higher capacities when cycled at faster rates.

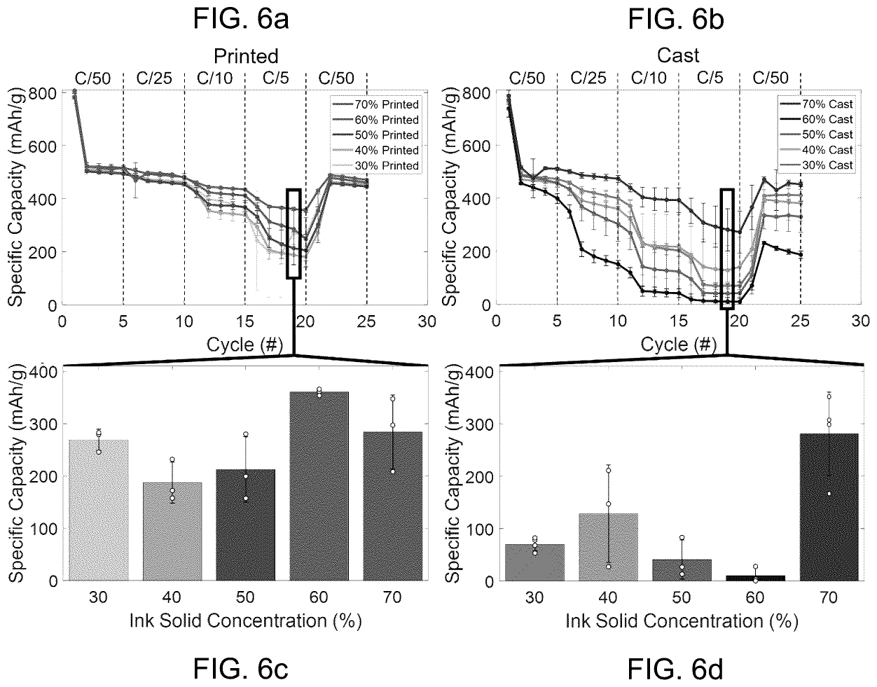

Cells made from printed and cast FeS₂ inks in the 30-70% solid range were cycled from C/50-C/5 and the results are plotted in FIGS. 6a-6d. Note that while these are all relatively slow rates, relatively high mass loading cathodes were studied relative to what is most commonly presented in literature. See A. K. Haridas et al., ChemSusChem 11(20), 3625 (2018); and G. F. Dewald et al., Ange. Chem. 133 (33), 18096 (2021). Within the first 5 cycles at C/50, all cells operate within the margin of error that was observed initially when cycling at C/50 (FIG. 5b), except for cells made from cathodes cast at 60% ink concentrations, which began to degrade uniformly. When stepping the rate up to C/25, the capacity amongst printed cells remained tightly coupled while the capacity amongst the cast cells separated and varied dramatically from C/25 to C/5. Amongst printed samples, capacity differences did not begin to manifest until C/10 and C/5, at which point a trend in the data emerges. At C/5, cells with cathodes printed from more concentrated inks are observed to correlate with higher cycling capacities. To highlight this trend, a snapshot of capacities plotted in the 19th cycle of FIG. 6a is presented in FIG. 6c, where there is a significant positive correlation between specific discharge capacity and ink concentration. This trend is not present to the same degree in the cells with cast cathodes (shown in FIGS. 6b and 6d), except for the cathodes made from 70% concentrated inks. Instead, the rate performance of the cast cells is generally inferior to the printed cells and the rate performance tends to decrease with increasing ink concentration from 40-60%. Curiously, this trend then reverses and the electrodes cast from the 70% ink concentration show significantly better rate performance.

The difference in performance between films produced from concentrated inks versus less concentrated inks is difficult to explain from differences in porosity, since it would be expected that rate performance should increase with increasing porosity. What may better explain the increase in capacity with increasing ink concentration is electrode ridging (see FIG. 4c). Amongst the printed cathodes, those printed with 30-50% solid inks had overlapping capacity versus cycle count profiles and exhibited little to no ridging. Meanwhile, cathodes printed from inks in the 60-70% range exhibited pronounced ridging and were amongst the most rate capable cathodes demonstrated. Amongst the cast cathodes, all performed relatively poorly at C/5 except for those cast from 70% solid inks, which surprisingly exhibited ridging. Even amongst non-ridged cathodes, printed as opposed to cast cathodes cycled with much higher capacity and better cell-to-cell uniformity. Printing is likely better at maintaining uniformity of mass along a large area coating (due to its use of constant velocity extrusion).

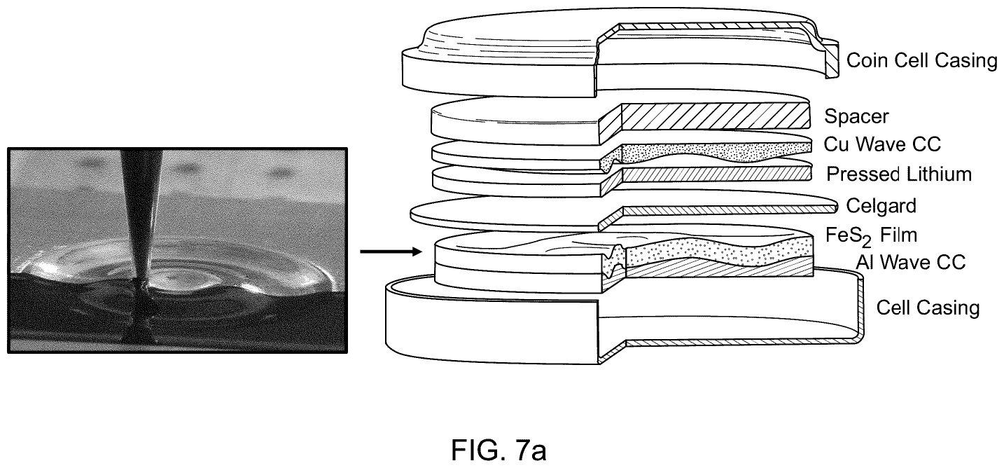

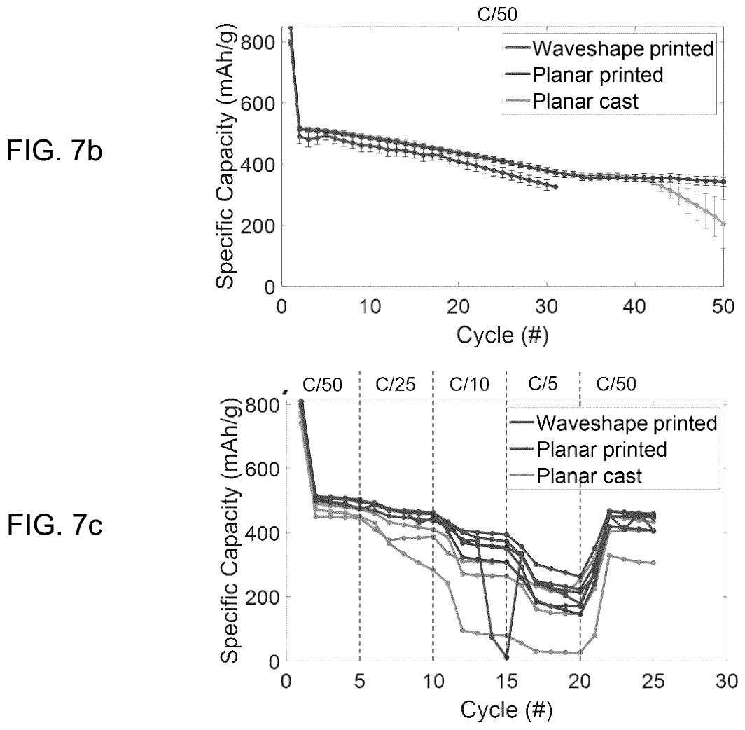

To provide proof-of-concept that additive manufacturing could be used to directly print electrode inks onto complex shapes for custom-form batteries, non-planar wave-shaped CCs were machined and used as printing substrates to evaluate the impact of non-planar architectures on cell performance. The wave shape was chosen to demonstrate conformal printing onto non-planar surfaces in a fashion that is not possible using a traditional casting method while also being compatible with CR2032 coin cell assembly, allowing for direct comparison against planar cells. On the cathode CC, 40% solid FeS₂ inks were syringe extruded directly onto a wave-shaped aluminum substrate as shown in the inset of FIG. 7a. During the printing of FeS₂ inks onto the custom shaped CCs, the substrates sat in a fixture allowing for accurate placement and alignment on the printer. Once the films were printed, they were then released from the fixture and dried using the same post-process protocols as planar films. On the anode side of the cell, copper wave-shaped CCs were machined, and lithium foil was pressed to shape. The cathode and anode CCs were designed such that the waves of the anode CC nested flush into the waves of the cathode CC.

Coin cell assembly was then carried out as previously described, except using the wave-shaped cell components, illustrated in FIG. 7a. The mass loading for all cathodes prepared was again 7 mg/cm². In wave-shaped cells, the CCs were designed such that the same wave spring deflection (and therefore pressure) was achieved between machined CCs and thin foils used in convention cells. At C/50, there are again only slight differences found between planar cast, planar printed, and wave-shaped printed films up to 50 cycles, as shown in FIG. 7b. However, complex shaped electrodes may be more sensitive to electrochemical cycling at faster rates. To evaluate rate capability, cells were cycled at C/50, C/25, C/10, C/5, then back to C/50 in 5 cycle increments, as shown in FIG. 7c. Here it was found that there were slight differences in capacity between printed wave-shaped cells, printed planar cells, and cast planar cells, with the former exhibiting the highest capacities and most stable cycling at faster cycling rates and the latter exhibiting lower capacities and less stable cycling at those same rates. Though the differences between data sets are slight and overlapping, an explanation for the improved performance in the wave-shaped cells could be attributed to the increased surface area of the wave-shaped electrodes. Regardless, the wave-shaped CC electrodes certainly did not cause a performance drop relative to planar geometries, which demonstrates that printing electrodes in complex, 3D geometries with sufficiently viscous ink formulations can be used to develop alternative form factor batteries.

Overall, DIW printing of FeS₂ electrodes onto custom-form CCs is demonstrated, however the unexpected observation of ridging correlating with improved rate capability may have further reaching impacts, beyond DIW printing and FeS₂. Ridging may be allotting space for the cathode to expand and contract throughout cycling, resulting in greater cycling stability. Alternatively, the ridged cathode-electrolyte interface may be providing regular intervals along the width of the electrode with less tortuous ion transport paths that enable ion transport deep within the electrode near the CC. This allows greater access to macroscale surface area over the volume of the cathode, creating an architectured electrode effect. 3D electrode architectures are generally shown to increase battery rate capability, so this result is not surprising. See D. S. Ashby et al., ACS Appl. Energy Mater. 3(9), 8402 (2020). However, in comparison to more complicated means of producing complex cathode microarchitectures (i.e., pillars, lattices, laser patterning), ridging is a simple and reproducible artifact of direct-write printing with high concentration inks. See D. S. Ashby et al., ACS Appl. Energy Mater. 3(9), 8402 (2020); L. Xue et al., Adv. Energy Mater. 11(14), 2100420 (2021); C. Shen et al., Electrochim. Acta 349, 136331 (2020); and C. Xu et al., J. Power Sources 492, 229638 (2021). Furthermore, it is potentially translatable to more high-throughput manufacturing methods, such as doctor-blading, slot-die coating, or flexographic printing, by notching the substrate, blade, or imprinting roll to create a ridging effect. Therefore, intentionally ridged electrodes can be a viable and inexpensive route toward improving the rate and power density of advanced energy storage systems.

In general, the inks can be deposited by a variety of deposition methods, including extrusion methods (e.g., DIW), casting, slot die printing, etc. With sufficiently high viscosity inks, these deposition methods can provide ridged electrodes. In general, the method can be used to deposit inks comprising a wide variety of electrochemically active electrode materials. For example, the method can be used to fabricate conversion cathodes, comprising electrochemically active electrode materials such as iron disulfide, iron trifluoride, carbon monofluoride, or sulfur. The method can be used to fabricate intercalation cathodes, comprising electrochemically active electrode materials such as lithium iron phosphate or lithium cobalt oxide. The method can be used to fabricate intercalation anodes, comprising electrochemically active electrode materials such as lithium titanate or graphite. The method can also be used to fabricate conversion and alloy anodes, such as spinel oxides (e.g., Fe₃O₄), rock-salt oxides, or silicon. For example, the conductive additive can comprise carbon, such as carbon black, carbon nanotubes, or reduced carbon. A wide variety of binder materials can be used, such as polyvinyldifluoride, polyimide, polyacrylate, polytetrafluoroethylene, styrene-butadiene copolymer, or carboxymethyl cellulose. A wide variety of solvents can be used to dissolve the binder. For example, dependent on the solubility of the binder material and drying conditions used, the solvent can comprise N-methyl-2-pyrrolidone, dimethylformamide, or water. The relative portions of these materials can be varied, depending on the ink properties desired.

The present invention has been described as ridged 3-dimensional battery electrodes for enhancing rate capability. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method for fabricating a battery electrode comprising depositing an ink on a current collector, wherein the ink comprises particles of an electrochemically active electrode material, a conductive additive, a binder, and a solvent.

2. The method of claim 1, wherein the battery electrode comprises a conversion cathode or an intercalation cathode.

3. The method of claim 2, wherein the electrochemically active electrode material comprises iron disulfide.

4. The method of claim 2, wherein the electrochemically active electrode material comprises iron trifluoride, carbon monofluoride, or sulfur.

5. The method of claim 2, wherein the electrochemically active electrode material comprises lithium iron phosphate or lithium cobalt oxide.

6. The method of claim 1, wherein the battery electrode comprises an intercalation anode, conversion anode, or Li-alloying anode.

7. The method of claim 6, wherein the electrochemically active electrode material comprises lithium titanate or graphite.

8. The method of claim 6, wherein the electrochemically active electrode material comprises a spinel oxide, rock-salt oxide, or silicon.

9. The method of claim 1, wherein the conductive additive comprises carbon.

10. The method of claim 1, wherein the battery electrode comprises a planar electrode.

11. The method of claim 1, wherein the battery electrode comprises a non-planar electrode.

12. The method of claim 1, wherein the battery electrode comprises a ridged electrode.

13. The method of claim 1, wherein the ink has a yield stress greater than 1 Pa.

14. The method of claim 1, wherein the depositing comprises extrusion printing.

15. The method of claim 1, wherein the depositing comprises casting or slot die printing.

16. An ink comprising particles of an electrochemically active electrode material, a conductive additive, a binder, and a solvent.

17. A ridged 3-dimensional battery electrode comprising an ink deposited on a current collector, wherein the ink comprises particles of an electrochemically active electrode material, a conductive additive, a binder, and a solvent.
